(19) United States
(12) Patent Application Publication
(10) Pub. No.: US 2014/0320728 A1
(43) Pub. Date: Oct. 30, 2014

(54) OPTICAL MEMBER, IMAGE PICKUP APPARATUS, AND METHOD FOR MANUFACTURING OPTICAL MEMBER

(71) Applicant: CANON KABUSHIKI KAISHA, Tokyo (JP)

(72) Inventors: Akira Sugiyama, Yokohama-shi (JP); Zuyi Zhang, Yokohama-shi (JP); Yoshinori Kotani, Yokohama-shi (JP); Akiko Takei, Fujisawa-shi (JP); Kenji Takashima, Tokyo (JP); Naoyuki Koketsu, Tokyo (JP)

(21) Appl. No.: 14/358,883

(22) PCT Filed: Nov. 6, 2012
(86) PCT No.: PCT/JP2012/007110

§ 371 Date: May 16, 2014

(30) Foreign Application Priority Data
Nov. 18, 2011 (JP) 2011-253070
Oct. 5, 2012 (JP) 2012-222900

(51) Int. Cl. C03C 15/00; H04N 5/225; B32B 3/26; C03C 17/02; B32B 17/00

(52) U.S. Cl. CPC C03C 15/00; C03C 17/02; B32B 17/00; B32B 3/26; H04N 5/2254; C03C 2218/33; C03C 2217/23; B32B 2551/00; B32B 2307/40
USPC 348/340; 65/31; 428/312.6

(57) ABSTRACT

The present invention provides an optical member including a porous glass layer on the base member, wherein a ripple is suppressed.

The optical member includes the porous glass layer which is disposed on the base member and which has a thickness of 400 nm or more, wherein the porous glass layer includes at least a gradient region having a porosity increasing from the interface between the base member and the porous glass layer toward the surface of the porous glass layer, the porosity is continuous in the thickness direction from the base member to the surface of the porous glass layer, and a specific relational expression is satisfied.

### TECHNICAL FIELD

The present invention relates to an optical member provided with a porous glass layer on a base member and an image pickup apparatus provided with the optical member. In addition, the present invention relates to a method for manufacturing the optical member.

### BACKGROUND ART

In recent years, the industrial utilization of porous glasses as adsorbing agents, microcarrier supports, separation films, optical materials, and the like has been highly anticipated. In particular, porous glasses have a wide utilization range as optical members because of a characteristic of low refractive index.

As for a method for manufacturing a porous glass relatively easily, a method taking advantage of a phase separation phenomenon has been mentioned. A typical example of a base material for the porous glass exhibiting the phase separation phenomenon is borosilicate glass made from silicon oxide, boron oxide, an alkali metal oxide, and the like. In production, the phase separation phenomenon is induced by a heat treatment in which a molded borosilicate glass is held at a constant temperature (hereafter referred to as a phase separation treatment), and a non-silicon oxide rich phase, which is a soluble component, is eluted through etching with an acid solution. The skeleton constituting the thus produced porous glass is primarily silicon oxide. The skeleton diameter, the hole diameter, and the porosity of the porous glass have influences on the reflectance and the refractive index of the light.

NPL 1 discloses a configuration in which the porosity is controlled in etching in such a way that elution of a non-silicon oxide rich phase is allowed to become insufficient partly and, thereby, the refractive index increases from the surface toward the inside. Consequently, reflection at a porous glass surface is reduced.

Meanwhile, PTL 1 discloses a method for forming a porous glass layer on a base member. Specifically, a film containing borosilicate glass (phase-separable glass) is formed on a base member by a printing method, and a porous glass layer is formed on the base member by a phase separation treatment and an etching treatment.

### CITATION LIST

### Patent Literature

PTL 1: Japanese Patent Laid-Open No. 01-083583

### Non Patent Literature

NPL 1: J. Opt. Soc. Am., Vol. 66, No. 6, 1976

### SUMMARY OF INVENTION

### Technical Problem

In the case where several micrometers of porous glass layer is formed on the base member as described in PTL 1, when light is incident on the porous glass surface, the light reflected at the porous glass surface interferes with the light reflected at the interface between the base member and the porous glass, so that a ripple (interference fringe) occurs.

NPL 1 does not disclose a configuration in which a porous glass layer is disposed on a base member. According to the method described in NPL 1, it is difficult to control the degree of proceeding of etching and, therefore, it is difficult to control the refractive index. In addition, a non-silicon oxide rich phase, which is a soluble component, remains and, thereby, the water resistance is degraded, so that problems, e.g., clouding, in the use as an optical member occur.

The present invention provides an optical member including a porous glass layer on a base member, wherein a ripple is suppressed, and a method for manufacturing the optical member easily.

### Solution to Problem

An optical member according to an aspect of the present invention is provided with a base member and a porous glass layer which is disposed on the above-described base member and which has a thickness of 400 nm or more, wherein the above-described porous glass layer includes at least a gradient region having a porosity increasing from the interface between the above-described base member and the above-described porous glass layer toward the surface of the porous glass layer, the porosity is continuous in the thickness direction from the above-described base member to the surface of the above-described porous glass layer, and the porosity difference P (%) between two ends of the above-described gradient region and the thickness T (nm) of the above-described gradient region satisfy the relationship represented by P/T less than or equal to 0.60.

A method for manufacturing an optical member provided with a porous glass layer disposed on a base member, according to an aspect of the present invention, includes the steps of forming a non-phase-separable second base material layer on a non-phase-separable first base material layer containing silicon, forming a phase-separable glass layer including a composition gradient region by mutually diffusing silicon contained in the above-described first base material layer and a component contained in the above-described second base material layer, forming a phase-separated glass layer by phase-separating the above-described phase-separable glass layer, and forming a porous glass layer on the base member by etching the above-described phase-separated glass layer.

### Advantageous Effects of Invention

According to aspects of the present invention, an optical member including a porous glass layer on a base member, wherein a ripple is suppressed, and a method for manufacturing the optical member easily are provided.

### BRIEF DESCRIPTION OF DRAWINGS

FIG. 1 is a schematic sectional view showing an example of an optical member according to an aspect of the present invention.

FIG. 2 is an electron micrograph of a cross-section of an optical member 1 produced in an example.

FIG. 3 is a diagram illustrating a porosity.

FIG. 4A is a diagram illustrating an example of a method for acquiring a gradient region.

FIG. 4B is a diagram illustrating changes in the porosity in the thickness direction.

FIG. 5A is a diagram illustrating an average hole diameter.

FIG. 5B is a diagram illustrating an average skeleton diameter.

FIG. 6 is a schematic diagram showing an image pickup apparatus according to an aspect of the present invention.

FIG. 7A is a schematic sectional view illustrating an example of a method for manufacturing an optical member according to an aspect of the present invention.

FIG. 7B is a schematic sectional view illustrating an example of a method for manufacturing an optical member according to an aspect of the present invention.

FIG. 7C is a schematic sectional view illustrating an example of a method for manufacturing an optical member according to an aspect of the present invention.

FIG. 8 is an electron micrograph of a cross-section of an optical member 4 produced in an example.

FIG. 9 is a diagram showing the wavelength dependence of reflectance of optical members 1 to 4 in examples.

### DESCRIPTION OF EMBODIMENTS

The present invention will be described below in detail with reference to the embodiments according to the present invention. Well known or publicly known technologies in the related art are adopted for the portions not specifically shown in the drawings and the descriptions in the present specification.

The term “phase separation” that forms a porous structure according to an aspect of the present invention will be described with reference to an example in which borosilicate glass containing silicon oxide, boron oxide, and an oxide having an alkali metal is used as a glass body. The term “phase separation” refers to separation of a phase with a composition of the oxide having an alkali metal and the boron oxide larger than the composition before the phase separation occurs (non-silicon oxide rich phase) from a phase with a composition of the oxide having an alkali metal and the boron oxide smaller than the composition before the phase separation occurs (silicon oxide rich phase) in the inside of glass, where the structures are on a scale of several nanometers to several ten micrometers. The phase-separated glass is subjected to an etching treatment to remove the non-silicon oxide rich phase, so that a porous structure is formed in the glass body.

The phase separation is classified into a spinodal type and a binodal type. A fine hole of the porous glass obtained by spinodal type phase separation is a through hole connected from the surface to the inside. More specifically, the structure derived from the spinodal type phase separation is an “ant nest”-shaped structure in which holes are three-dimensionally connected. The skeleton made from silicon oxide can be regarded as a “nest” and a through hole can be regarded as a “burrow”. Meanwhile, a porous glass obtained by binodal type phase separation has a structure in which independent holes, each surrounded by a closed curved surface substantially in the shape of a sphere, are present in the skeleton made from silicon oxide discontinuously. The hole derived from spinodal type phase separation and the hole derived from binodal type phase separation are determined and distinguished on the basis of the result of observation of their shapes by using an electron microscope. In addition, the spinodal type phase separation and the binodal type phase separation are specified by controlling the composition of the glass body and the temperature in phase separation.

### Optical Member

Explanations will be made below specifically with reference to an optical member 203 which is an example of the optical member according to an aspect of the present invention and which includes a porous glass layer 202 on a base member 105, although the present invention is not limited to this example.

FIG. 1 shows an example of a schematic sectional view of the optical member according to an aspect of the present invention.

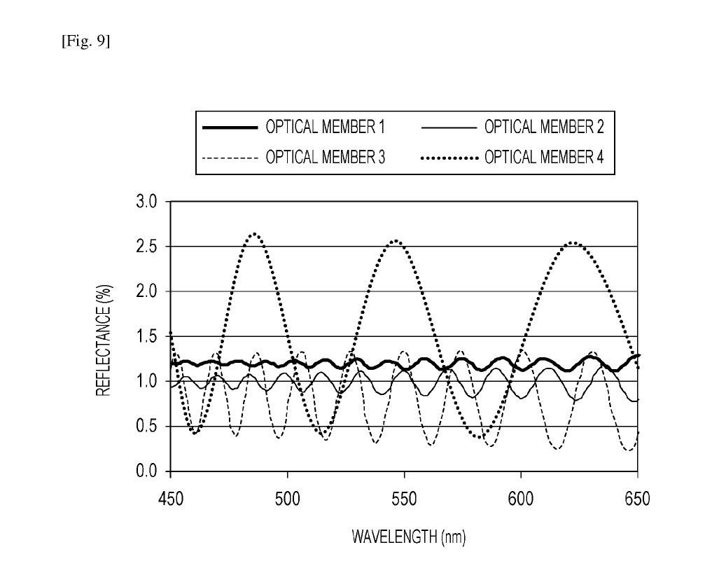

The optical member 203 according to an aspect of the present invention is provided with a porous glass layer 202 having a porous structure including continuous holes derived from spinodal type phase separation on a base member 105. The porous glass layer 202 is a low-refractive index film and is expected to be utilized as an optical member because reflection at the interface between the porous glass layer 202 and the air (surface of the porous glass layer 202) is suppressed. However, in the optical member provided with the porous glass layer 202 on the base member 105, a ripple phenomenon occurs, where an interference fringe appears in the reflected light because of an interference effect of the light reflected at the surface of the porous glass layer 202 and the light reflected at the interface between the base member 105 and the porous glass layer 202. In particular, this interference effect is enhanced and the ripple phenomenon appears considerably in the case where the thickness of the porous glass layer 202 is more than or equal to 400 nm and less than or equal to 50 micrometers. When the reflectance is measured and a graph is prepared while the horizontal axis indicates the wavelength and the vertical axis indicates the reflectance, the ripple is represented by the shape in which the magnitude fluctuates periodically like a sinusoidal wave (refer to Optical member 4 in FIG. 9). If such a ripple is present, the wavelength dependence of the reflectance is enhanced, and suitability for the optical member may be degraded.

The optical member 203 according to an aspect of the present invention has a configuration in which the porosity is continuous in the thickness direction from the base member 105 to the surface of the porous glass layer 202, the porous glass layer 202 includes at least a gradient region 107 having a porosity increasing from the interface between the base member 105 and the porous glass layer 202 toward the surface of the porous glass layer 202, and the porosity difference P (%) obtained by subtracting the porosity of an end portion of the gradient region 107 in the base member 105 side from the porosity of an end portion of the gradient region 107 in the surface side of the porous glass layer 202 and the thickness T (nm) of the gradient region 107 satisfy the relationship represented by Formula 1 described below. P/T less than or equal to 0.60 Formula 1

In the example shown in FIG. 1, the porosity of the end portion of the gradient region 107 in the base member 105 side is 0% and, therefore, P is represented by the porosity at the interface between the gradient region 107 and a non-gradient region 106. Here, the gradient region 107 having an increasing porosity, according to an aspect of the present invention, refers to a gradient region exhibiting a porosity difference of more than 2 or P/T of more than 0.00 (nm/%).

A sharp change in the refractive index at the interface between the base member 105 and the porous glass layer 202 is suppressed by the configuration according to aspects of the present invention, and reflection at this interface is substantially suppressed. As a result, it is possible to suppress a ripple due to interference of the light reflected at the surface of the porous glass layer 202 with the light reflected at the interface between the base member 105 and the porous glass layer 202.

In the configuration according to an aspect of the present invention, at least the gradient region 107 having a porosity increasing from the interface between the base member 105 and the porous glass layer 202 toward the surface of the porous glass layer 202. In the configuration, the porosity can increase in the whole glass layer toward the surface.

According to the above-described configuration, a sharp change in the refractive index is suppressed and, therefore, lower reflection may be realized.

A plurality of gradient regions may be present in the porous glass layer 202. In that case, at least any one of the gradient regions satisfy the relationship represented by Formula 1.

If P/T is more than 0.60, it is difficult to realize low reflectance suitable for the use as an optical member and, in addition, in some cases, an interference fringe is clearly visually observed. P/T is more preferably 0.30 or less, and further preferably 0.10 or less. In the case where P/T is within the above-described range, lower reflection is realized and an interference fringe is not easily visually identified.

Processing to calculate P/T is performed by binarizing an electron microscopy image into a skeleton portion and a hole portion. Specifically, the scanning electron microscope (FE-SEM S-4800, produced by Hitachi, Ltd.) is used and a cross-sectional portion of the porous glass layer 202 of the optical member is observed at an acceleration voltage of 5.0 kV at a magnification of 1× to 100,000×, where shading of the whole portion of a change region of the skeleton is observed easily. The image is stored. In the case where it is difficult to observe the whole portion of a change region in one field of view, images of a plurality of fields of view may be stored and an operation of making into a graphical form, as described below, may be performed a plurality of times.

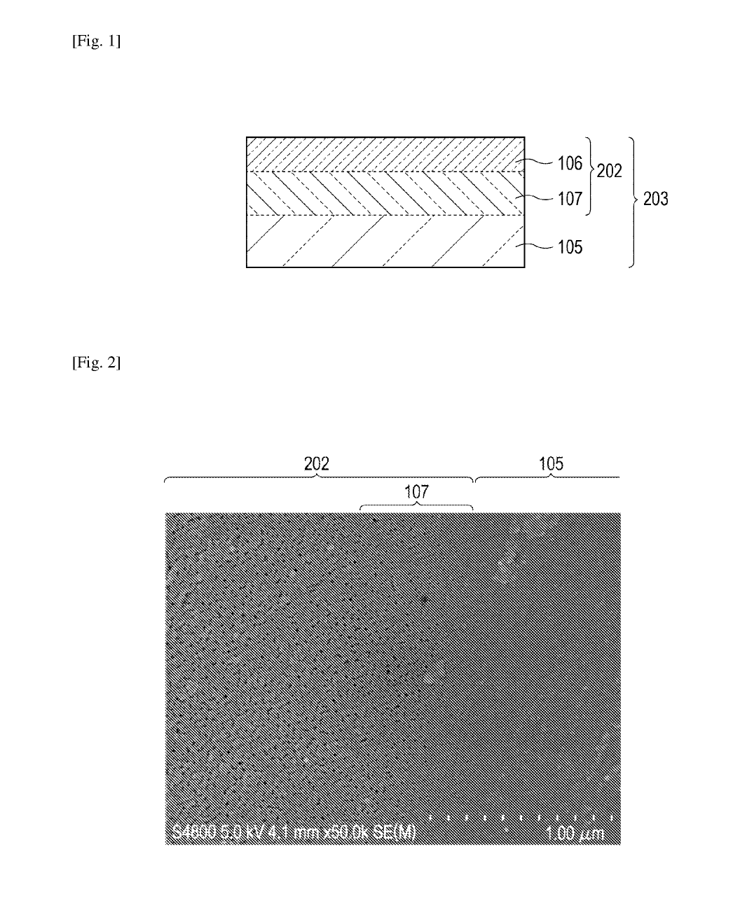

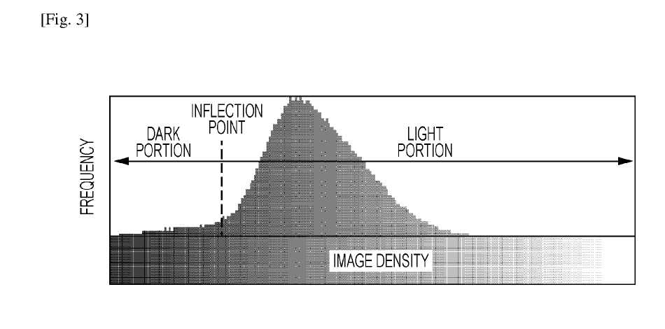

A method for calculating P/T will be described below in detail with reference to FIG. 2 showing an example of a cross-sectional image of an optical member according to an aspect of the present invention. FIG. 2 shows a magnified cross-section of the optical member at a magnification of 50,000×, and the porous glass layer 202 includes the gradient region 107 exhibiting a porosity gradient from the base member 105 having the porosity of 0 toward the optical member surface portion. The resulting SEM image is made into a graphical form on the basis of the frequency of image density by using image analysis software. FIG. 3 is a diagram showing the frequency on the basis of the image density of a porous glass having a spinodal type porous structure. A portion to the right of the inflection point of the change in the image density shown in FIG. 3 indicates the skeleton (or base member portion).

The light portion (skeleton portion, base member portion) and the dark potion (hole portion) are binarized into white and black (pixels representing the image are binarized), where an inflection point in the higher image density side with respect to the peak position is taken as a threshold value. Then, the binarized image is subjected to calculation of a black density on the basis of thickness of the optical member. Correction is performed in such a way that the black density of a portion which is clearly determined to be a base member portion from the original image is adjusted to be a porosity of 0, the porosity of the optical member in the thickness direction is calculated, and a graph is made, where the horizontal axis indicates the distance in the thickness direction and the vertical axis indicates the porosity. The data of the porosity is taken at an interval of 4 nm in the thickness direction.

In the case where the electron microscopy image in which the porous glass layer 202 and the base member 105 are observed in the same field of view is binarized in the above-described method, the brightness of the skeleton in the image region of the porous glass layer 202 may become higher than the brightness of the base member 105 portion. As a result, in an image in which the base member 105 and the porous glass layer 202 are observed in the same field of view, part of holes may be determined to be skeletons, so that the calculated porosity may become smaller than an actual porosity and, therefore, be different from the actual porosity. Meanwhile, for the same reason, in the case where an observation image of the outermost portion of the porous glass layer 202 is used, the value of porosity may become different from the actual porosity and, therefore, care is needed. In such a case, the porosity of the porous glass layer 202 is corrected by the following technique.

Specifically, as for an image in which an interface between the base member 105 and the porous glass layer 202 is present and the like, an image of observation of the porous glass layer 202 in FIG. 2 at an optional magnification is subjected to a binarization operation described later, the porosity is calculated and, thereby, correction is performed.

In this case, it is necessary to select a field of view including only the porous glass layer 202. That is, image analysis software is used, the SEM image of the portion of the porous glass layer 202 is made into a graphical form on the basis of the frequency of image density, and the light portion (skeleton portion) and the dark potion (hole portion) are binarized into white and black, where an inflection point near the peak position is taken as a threshold value. Calculation is performed in such a way that the porosity of the dark portion becomes 100% and the porosity of the light portion becomes 0%.

The porosity in the thickness direction is corrected in such a way that the value of the porosity obtained in the case of the porous glass layer 202 alone and the porosity of a place corresponding thereto become equal.

Specifically, when the thickness direction is divided by regions of 40 nm or less, an average porosity value of the regions concerned is equalized to the average porosity value obtained in the case of the porous glass layer 202 alone. Likewise, in the case where images in a plurality of fields of view in the thickness direction are observed, it is necessary that the value of the porosity is corrected.

In the case where the gradient region 107 is present throughout the porous glass layer 202, correction is performed in such a way that the porosity calculated from a surface observation image of the optical member and the porosity of the surface portion of the cross-sectional observation image become equal.

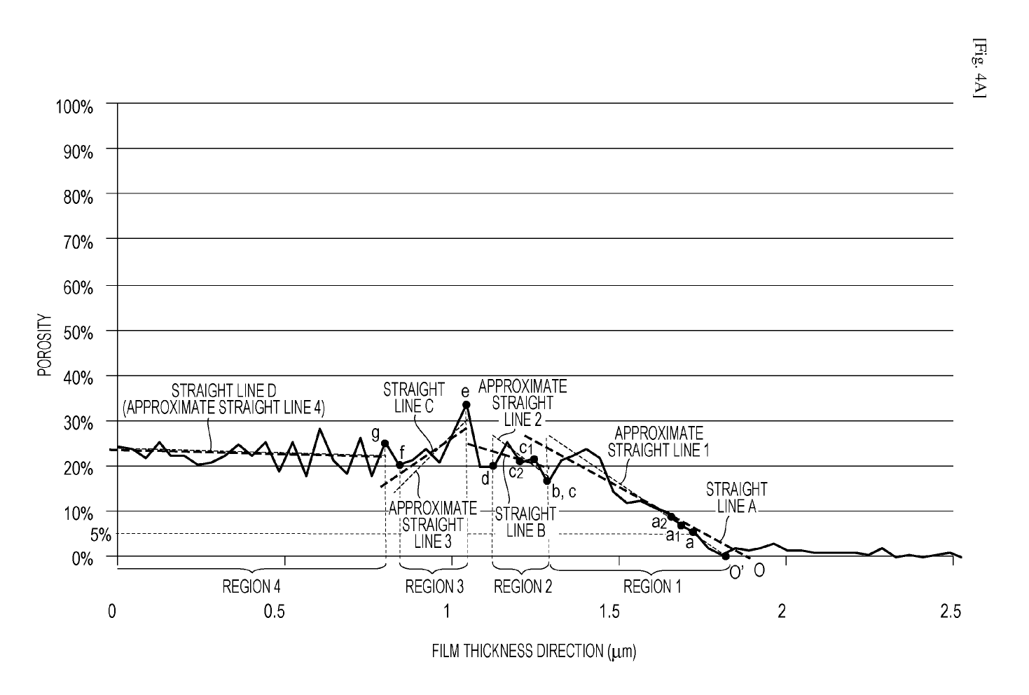

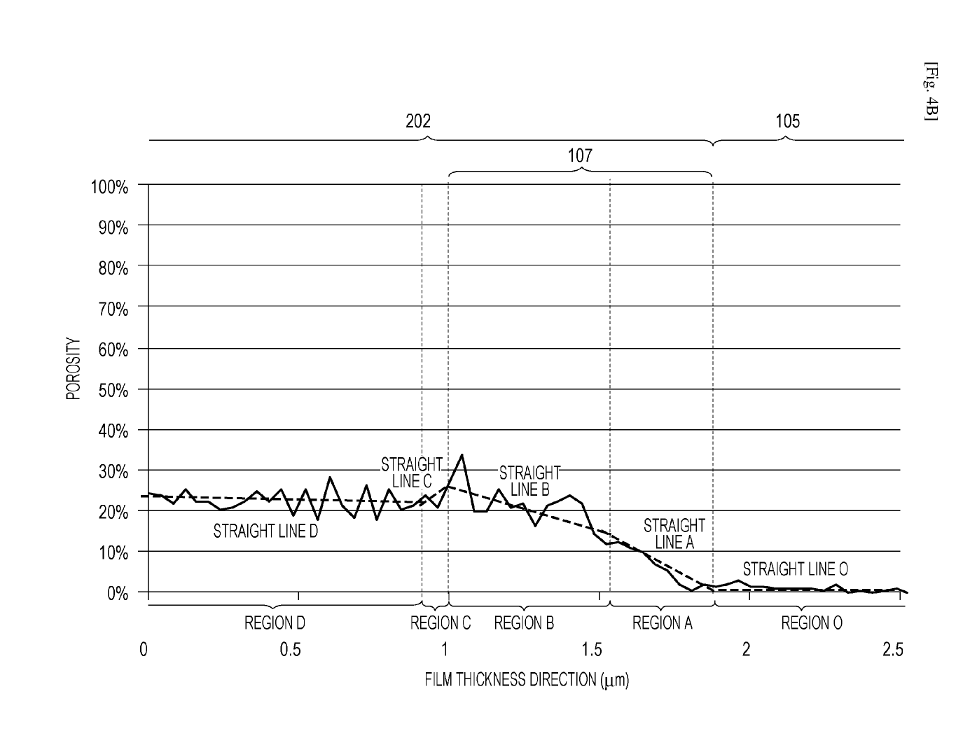

Specifically, the gradient region 107 may be determined as described below. A method for calculating a gradient region will be described with reference to FIG. 4A as an example. Measured data are converted to an average value on a 40 nm basis and Graph A (solid line in FIG. 4A) is formed.

1. In Graph A, a point at which the porosity reaches 5% for the first time when the porosity is observed from the base member (right side of FIG. 4A) toward the surface of the porous glass layer (left side of FIG. 4A) is specified to be Point a. Points on Graph A corresponding to positions 40 nm and 80 nm away from Point a toward the surface side of the porous glass layer (left side of FIG. 4A) are specified to be Points a₁ and a₂, respectively. A regression line is formed by a least square method on the basis of three points, Points a, a₁, and a₂, and is specified to be Approximate straight line 1 (thin dotted line in FIG. 4A).

2. Approximate straight line 1 described above is extended from Point a₂ in the direction of the surface of the porous glass layer, and a point on Graph A at which the porosity difference between Approximate straight line 1 and Graph A reaches 5% for the first time in the direction toward the surface of the porous glass layer is specified to be Point b. A regression line is formed by a least square method on the basis of porosities at points on Graph A, the points dividing a region from an intersection O′ of Approximate straight line 1 and a line indicating the porosity of 0% to Point b (Region 1) into 10 equal parts, so that Straight line A (thick dotted line in FIG. 4A) is formed. The position at which the porosity of Straight line A is 0% is specified to be a start point O of the gradient region.

In the case where a point of porosity of 0% on Approximate straight line 1 is located at a distance of 400 nm or more from a start point of the porous structure observed in the SEM image, the porosity may change discontinuously between the porous structure portion and the base member. Therefore, it is determined that the place concerned does not have a gradient structure and the following procedure is executed.

3. Straight line A described above is extended from Point b in the direction of the surface, and a point on Graph A at which the porosity difference between Straight line A and a point on Graph A reaches 5% for the first time in the direction toward the surface of the porous glass layer is specified to be Point c. In FIG. 4A, Point b coincides with Point c. Points on Graph A corresponding to positions 40 nm and 80 nm away from Point c toward the surface side of the porous glass layer are specified to be Points c₁ and c₂, respectively. Approximate straight line 2 (thin dotted line in FIG. 4A) is formed on the basis of three points, Points c, c₁, and c₂, in the same manner as that of formation of Approximate straight line 1.

4. Approximate straight line 2 described above is extended from Point c₂ in the direction of the surface of the porous glass layer, and a point on Graph A at which the porosity difference between Approximate straight line 2 and Graph A reaches 5% for the first time in the direction toward the surface of the porous glass layer is specified to be Point d. Straight line B (thick dotted line in FIG. 4A) is formed on the basis of the porosity values at points dividing a region from Point c to Point d (Region 2) into 10 equal parts in the same manner as that of Straight line A.

An intersection of Straight line B and Straight line A is specified to be an end point of the Region 1 in the direction from the base member. In the case where an intersection is not present within the range of Region 2, Straight line A and Straight line B may be extended appropriately so as to intersect.

5. The same operations as those in the above-described items 3 and 4 are repeated in the surface direction (left side of FIG. 4A), so as to form Straight line B, Straight line C, Straight line D, and so forth. Each straight line is extended to the intersection with the adjacent straight lines, Straight line O indicating the porosity of 0% is formed from Point 0 on Straight line A in the direction of the base member center, and the resulting lines are bonded, so as to form Graph B (broken line in FIG. 4B).

Here, each of the intersections of the straight line O and the straight line A, the straight line A and the straight line B, the straight line B and the straight line C, and the straight line C and the straight line D serves as one of the start points and the end points of Regions A to D.

In the case where an approximate straight line formed on the basis of three points on Graph A, a point at which the porosity difference reaches 5% and points located 40 nm and 80 nm ahead thereof, by a least square method is extended in the film surface direction in the operations of the above-described items 1 and 3, when a point at which the porosity difference from Graph A reaches 5% is not present, the resulting approximate straight line is specified to be a straight line and the operation is finished.

The value of P/T is calculated with respect to each of Region A, Region B, Region C, Region D, and so forth calculated above.

Here, the value of P of Region A is 15%, T is 338 nm, and P/T is 0.04 (nm/%). The value of P of Region B is 11%, T is 543 nm, and P/T is 0.02 (nm/%). The value of P of Region C is -4%, T is 98 nm, and P/T is −0.04 (nm/%). The value of P/T of Region D is 0.00 (nm/%).

In the case where a difference in P/T between adjacent region is less than 0.10 (nm/%), the regions of the straight lines concerned may be combined as one gradient region 107. In the case where P/T of a region is 0 or negative, the region is not specified to be the gradient region according to the present invention.

When a plurality of gradient regions are combined as one gradient region 107, P/T of the gradient region is specified to be an average value of P/T of the individual straight lines and is 0.03 (nm/%) in the above-described case. Meanwhile, the thickness of the gradient region 107 may be a sum of the thicknesses of the individual gradient regions. In the above-described case, the thickness of the gradient region 107 is 881 nm which is a sum of the thicknesses of Region A and Region B.

The resulting Graph B corresponds to FIG. 2. The portion having a porosity of 0 is the base member 105, the portion having a porosity of not 0 is the porous glass layer 202 and the porosity is continuous in the thickness direction from the base member 105 to the surface of the porous glass layer 202. A gradient region in which the porosity increases from the interface between the base member 105 and the porous glass layer 202 toward the surface of the porous glass layer 202 is present therein.

The smallest value of measurement interval in the thickness direction is 40 nm Therefore, in the above-described operation, a gradient region of 40 nm or more can be determined by calculation. In the case where a gradient region of 40 nm or more is not present on the basis of this operation, the thickness of the gradient region is specified to be 40 nm (T=40 nm) which is the smallest value of measurement interval and is used for calculation of P/T.

The whole porous glass layer 202 may be a porosity gradient region 107. In that case, the porosity of the surface of the porous glass layer 202 is taken as the porosity P (%) of the gradient region 107 and the thickness of the porous glass layer 202 is taken as the thickness T (nm) of the gradient region 107.

In the present invention, it is necessary that the porosity is continuous in the thickness direction from the base member 105 to the surface of the porous glass layer 202.

In the case where the porosity is not continuous, a sharp change in the refractive index occurs in the interface portion, so as to cause an occurrence of ripple and degrade the reflectance characteristics.

The term “porosity is continuous” refers to that, when the porosity of every 4 nm of region is calculated in Graph A described above, the difference in porosity between adjacent two regions, 4 nm each, is 2.5% or less.

For example, in the case where Region A and Region B are disposed in that order from the base member side, the porosity of Region A is specified to be x%, and the porosity of Region B is specified to be y%, the term “difference in porosity” refers to ly-xl. Here, the values of x and y include the value of 0% (for example, base member portion).

The gradient region 107 of the porous glass layer 202 may be any gradient region insofar as Formula 1 described above is satisfied. However, It is desirable that a change in the porosity be linear. In the case of nonlinear, a portion in which a change in the porosity is gentle and a portion in which a change in the porosity is sharp are present. Therefore, it is believed that the reflectance increases because a portion in which the refractive index changes sharply is generated. Here, the term “linear” in the present invention refers to that when the gradient region 107 of the graph of the porosity is divided into 10 equal parts in the thickness direction and porosities of both end places are bonded with a straight line, deviations of all porosity values of the other 8 points from this straight line are 15% or less.

The thickness of the gradient region 107 is preferably 200 nm or more and 50.0 micrometers or less, and more preferably 400 nm or more and 50.0 micrometers or less. If the thickness is less than 200 nm, a sharp change in the refractive index occurs easily at the interface, and an effect of suppressing reflection at the surface of the porous glass layer 202 tends to be reduced because the porosity in itself of the porous glass layer 202 is reduced. In the case where the thickness of the gradient region 107 is 100 nm or more, an effect of suppressing a ripple is exhibited considerably on the basis of the measurement of reflectance. If the thickness is more than 50.0 micrometers, an influence of the haze increases and the handleability as an optical member is degraded.

The thickness of the porous glass layer 202 is preferably 400 nm or more and 50.0 micrometers or less, and more preferably 400 nm or more and 20.0 micrometers or less. If the thickness is more than 50.0 micrometers, an influence of the haze increases and the handleability as an optical member is degraded.

As for the thickness of the porous glass layer 202, specifically, a scanning electron microscope (FE-SEM S-4800, produced by Hitachi, Ltd.) is used and a SEM image (electron micrograph) at an acceleration voltage of 5.0 kV is taken. The thickness of the glass layer portion on the base member of the taken image is measured at 30 or more points and the average value thereof is used.

The porous glass layer 202 of the optical member 203 may include a region 106 having a constant porosity.

In the optical member 203 according to an aspect of the present invention, a film having a refractive index smaller than the refractive index of the porous glass layer 202 may be disposed on the surface of the porous glass layer 202.

A base material made from any material may be used as the base material 105 in accordance with the purpose. The material for the base material 105 can be, for example, quartz glass or quartz from the viewpoints of transparency, heat resistance, and strength. The base material 105 may have a configuration in which layers made from different materials are stacked.

The base material 105 can be transparent. The transmittance of the base material 105 is preferably 50% or more in the visible light region (wavelength region of 450 nm or more and 650 nm or less), and further preferably 60% or more. If the transmittance is less than 50%, problems may occur in the use as an optical member.

The base member 105 may be a material for low-pass filters, infrared-cut filters and lenses. The base member 105 according to an aspect of the present invention is so-called nonporous.

The porosity of the gradient region 107 of the porous glass layer 202 is not specifically limited, and is preferably 30% or more and 70% or less, and more preferably 40% or more and 60% or less. If the porosity is less than 30%, the advantages of the porosity are not fully utilized. If the porosity is more than 70%, the surface strength tends to be reduced unfavorably. The porosity is calculated by the above-described method.

The average hole diameter of the porous glass layer 202 is preferably 1 nm or more and 200 nm or less, and more preferably 5 nm or more and 100 nm or less. If the average hole diameter is less than 1 nm, the characteristics of the porous structure are not fully utilized. If the average hole diameter is more than 200 nm, the surface strength tends to be reduced unfavorably. In this regard, the average hole diameter can be smaller than the thickness of the porous glass layer 202.

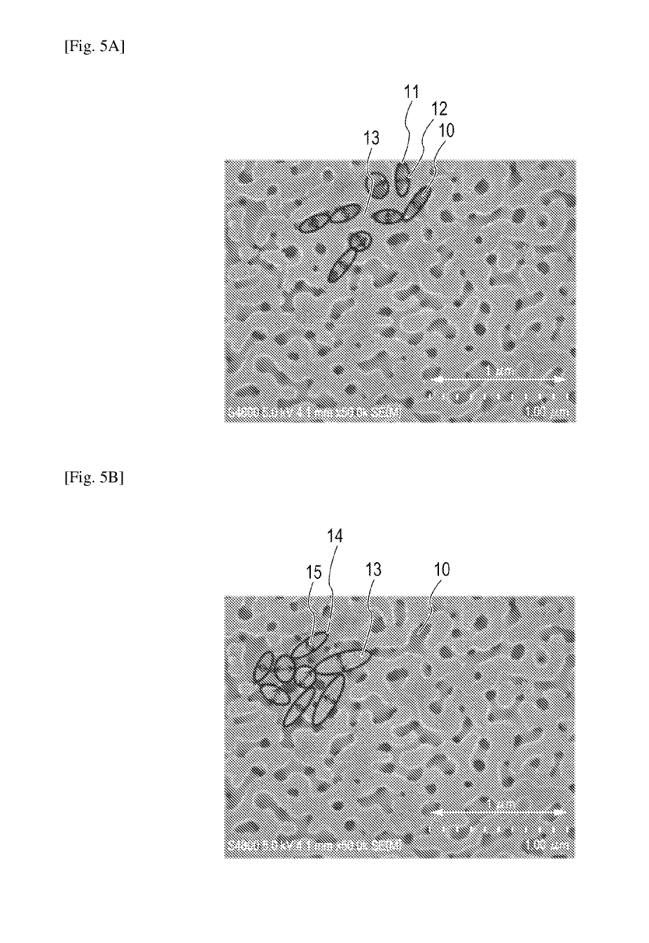

The average hole diameter in the present invention is defined as an average value of the minor axes of a plurality of approximated ellipses, where holes in the porous body surface are approximated by the plurality of ellipses. Specifically, for example, as shown in FIG. 5A, an electron micrograph of the porous body surface is used, holes 10 are approximated by a plurality of ellipses 11, an average value of the minor axes 12 of the individual ellipses is determined and, thereby, the average hole diameter is obtained. At least 30 points are measured and an average value thereof is determined

The average skeleton diameter of the porous glass layer 202 is preferably 1 nm or more and 100 nm or less. If the average skeleton diameter is more than 100 nm, the light is scattered considerably, and the transmittance is reduced significantly. If the average skeleton diameter is less than 1 nm, the strength of the porous glass layer 202 tends to become small.

The average skeleton diameter in the present invention is defined as an average value of the minor axes of a plurality of approximated ellipses, where the skeleton of the porous body surface is approximated by the plurality of ellipses. Specifically, for example, as shown in FIG. 5B, an electron micrograph of the porous body surface is used, the skeleton 13 is approximated by a plurality of ellipses 14, an average value of the minor axes 15 of the individual ellipses is determined and, thereby, the average skeleton diameter is obtained. At least 30 points are measured and an average value thereof is determined.

It is noted that the scattering of light is influenced by the thickness and the like of the optical member in combination and, therefore, is not univocally determined by only the hole diameter and the skeleton diameter. The hole diameter and the skeleton diameter of the porous glass layer 202 may be controlled by the material serving as a raw material and the heat treatment condition in spinodal type phase separation.

Specifically, the optical members according to aspects of the present invention may be used for optical members, e.g., polarizers used in various displays of televisions, computers, and the like and liquid crystal display apparatuses, finder lenses for cameras, prisms, fly-eye lenses, and toric lenses. The optical members may be further used for various lenses of image taking optical systems, observation optical systems, e.g., binoculars, projection optical systems used for liquid crystal projectors and the like, and scanning optical systems used for laser beam printers and the like, in which porous glasses are used.

The optical members according to aspects of the present invention may be mounted on image pickup apparatuses, e.g., digital cameras and digital video cameras. FIG. 6 is a schematic sectional diagram showing a camera (image pickup apparatus) that uses an optical member according to an embodiment of the present invention, specifically, an image pickup apparatus that forms a subject image from a lens onto an image pickup element through an optical filter. An image pickup apparatus 300 includes a main body 310 and a detachable lens 320. The image pickup apparatus, e.g., a digital single-lens reflex camera, obtains imaging screens at various field angles by changing an imaging lens to be used for photographing to a lens having a different focal length. The main body 310 includes an image pickup element 311, an infrared-cut filter 312, a low-pass filter 313, and the optical member 203 according to an aspect of the present invention. The optical member 203 includes the base material 105 and the porous glass layer 202, as shown in FIG. 1.

The optical member 203 and the low-pass filter 313 may be formed integrally or be formed independently. The optical member 203 may be configured to also serve as a low-pass filter. That is, the base material 105 of the optical member 203 may be the low-pass filter.

The image pickup element 311 is held in a package (not shown in the drawing) and this package keeps the image pickup element 311 in a hermetically sealed state with a cover glass (not shown in the drawing). A sealing member, e.g., a double-sided tape, seals between the optical filters, e.g., the low-pass filter 313 and the infrared-cut filter 312, and the cover glass (not shown in the drawing). An example in which both the low-pass filter 313 and the infrared-cut filter 312 are provided will be described, although any one of them may be provided alone.

The porous glass layer 202 of the optical member 203 according to an aspect of the present invention has a spinodal type porous structure and, therefore, is excellent in terms of dustproof performance, e.g., suppression of dust adhesion. Consequently, the optical member 203 is disposed in such a way as to be located on the side opposite to the image pickup element 311 of the optical filter. The optical member can be disposed in such a way that the porous glass layer 202 is located farther from the image pickup element 311 than the base material 105 is. Put another way, the optical member 203 can be disposed in such a way that the base member 105 and the porous glass layer 202 are disposed in that order from the image pickup element 311 side.

Method for Manufacturing Optical Member

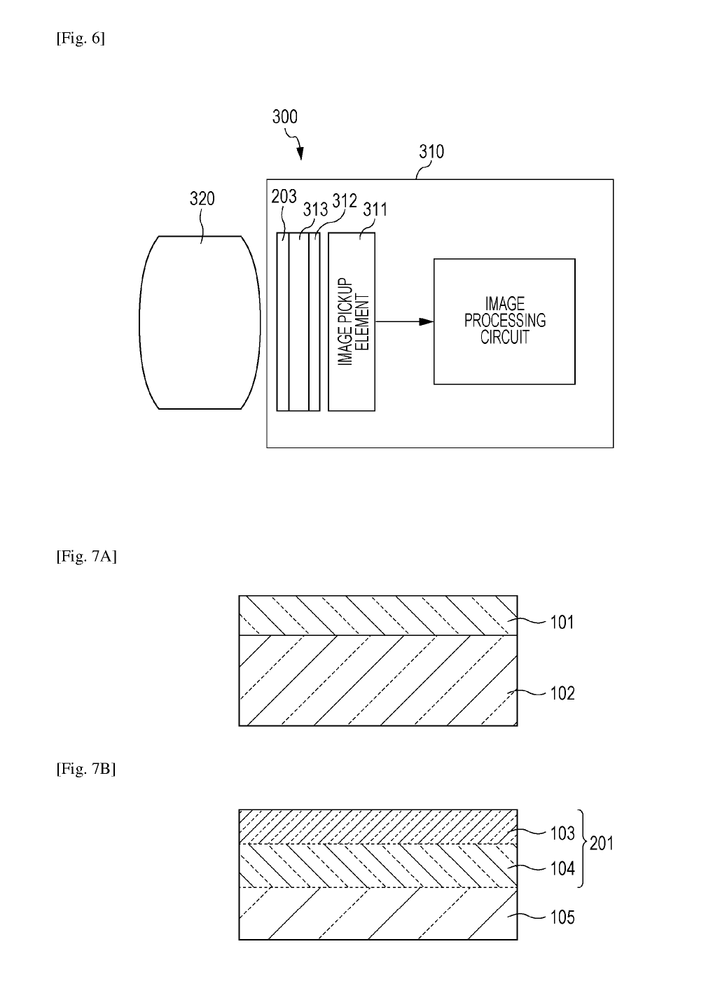

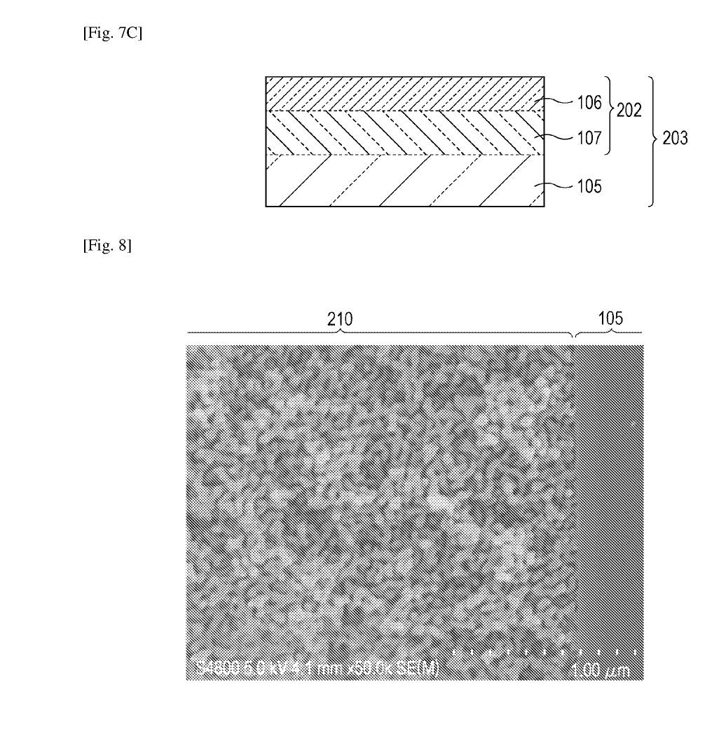

FIG. 7A to FIG. 7C are schematic diagrams illustrating a method for manufacturing an optical member according to an aspect of the present invention. The optical member according to an aspect of the present invention is configured to include a porous glass layer on a base member and is formed as described below. A non-phase-separable second base material layer is formed on a non-phase-separable first base material layer containing silicon. A phase-separable glass layer including a composition gradient region is formed by mutually diffusing components contained in the individual base material layers. A porous glass layer is formed on the base member by subjecting the phase-separable glass layer to a phase separation treatment and an etching treatment. The manufacturing method will be described below in detail with reference to FIG. 7A to FIG. 7C.

Step of Forming Non-Phase-Separable Second Base Material Layer

As shown in FIG. 7A, a non-phase-separable second base material layer 101 is formed on a non-phase-separable first base material layer 102 containing silicon. A term “non-phase-separable layer” refers to “layer which is not phase-separable”, and the phase separation property refers to a property that the above-described phase separation is induced by a heat treatment. Specifically, the non-phase-separable second base material layer 101 is made from a material having a small silicon content or containing no silicon and phase separation is not induced by a heat treatment at a temperature of 450 degrees (celsius) or higher and 750 degrees (celsius) or lower for 1 hour to 100 hours by itself.

The non-phase-separable second base material layer 101 is not specifically limited. Examples thereof include silicon oxide based glass I (base material glass composition: silicon oxide-boron oxide-alkali metal oxide), silicon oxide based glass II (base material glass composition: silicon oxide-boron oxide-alkali metal oxide-(alkaline-earth metal oxide, zinc oxide, aluminum oxide, zirconium oxide)), and titanium oxide based glass (base material glass composition: silicon oxide-boron oxide-calcium oxide-magnesium oxide-aluminum oxide-titanium oxide). Among them, borosilicate based glass composed of silicon oxide based glass I can be employed. In particular, alkali borate based glass composed of boron oxide-alkali metal oxide can be employed.

In general, as for the borosilicate based glass, phase separation of a glass having a composition in which the proportion of silicon oxide is 60.0 percent by weight or less tends not to be observed.

In the configuration of the manufacturing method according to an aspect of the present invention, as described later, diffusion of silicon from the first base material layer 102 is utilized, and the non-phase-separable second base material layer 101 is made to have a composition of a phase-separable glass layer. Therefore, the second base material layer 101 can have a small silicon content and especially have a silicon content smaller than the silicon content of the surface layer of the first base material layer 102. In particular, the difference between the silicon content of the surface layer of the first base material layer 102 and the silicon content of the second base material layer 101 is preferably 50.0 percent by weight or more, and more preferably 70.0 percent by weight or more. If the difference is less than 50.0 percent by weight, an effect of component diffusion may be reduced. Moreover, the second base material layer 101 can be configured to contain no silicon. In this regard, the surface layer of the first base material layer 102 refers to a region in which component diffusion may occur, as described later.

The silicon content is measured by the following method. That is, constituent elements are quantitatively analyzed by using an X-ray photoelectron spectrometer (XPS). As for the measuring apparatus, ESCALAB 220i-XL (produced by Thermo Scientific) may be used. In the measurement, an abundance ratio (atomic percent) among elements excluding oxygen is calculated. In the measurement of silicon content of a composition gradient region 104 described later, element analysis in the depth direction may be performed by repeating the XPS measurement and surface cutting through sputtering from the surface of the phase-separable glass layer 201.

The second base material layer 101 can have a composition which exhibits a phase separation property by increasing the silicon content. Specifically, as described above, borosilicate glass having a composition in which the proportion of silicon oxide is 60.0 percent by weight or less is suitable for use, and the proportion of silicon oxide in the composition is more preferably 30.0 percent by weight or less. An alkali borate based glass in which the proportion of silicon oxide is small may also be suitable for use.

The fusion temperature tends to increase as the silicon content increases. Therefore, the second base material layer 101 can have a smaller silicon content from the viewpoint of lowering of the fusion temperature.

The second base material layer 101 according to an aspect of the present invention has a thickness enough for forming a composition gradient region, and specifically, the thickness is preferably 100 nm or more. If the thickness is less than 100 nm, the thickness of the resulting porous glass layer 202 becomes less than 200 nm, the composition gradient region becomes small, a ripple suppression effect is reduced and, in addition, an effect of the low reflectance characteristic at the surface of the porous glass layer 202 is not obtained.

A method for forming the second base material layer 101 can be a method in which the second base material layer 101 is formed into a flat shape on the first base material layer 102 in order that mutual diffusion between the individual base material layers is induced in a plane uniformly. All manufacturing methods, e.g., a printing method, a vacuum evaporation method, a sputtering method, a spin coating method, and a dip coating method, capable of forming a film are mentioned. Among them, a printing method using screen printing is mentioned as a method suitable for forming a glass layer having any glass composition. Explanations will be made below with reference to a method by using a common screen printing method as an example. In the screen printing method, a glass powder is made into a paste and is printed by using a screen printing machine. Therefore, adjustment of the paste is necessary.

As for a method for manufacturing base glass serving as a glass powder, the base glass may be produced by a known method except that a raw material is prepared to have the composition of a predetermined glass. For example, production may be performed by heating and fusing the raw material containing supply sources of the individual components and, as necessary, by molding the raw material into a predetermined form. In the case where heating and fusing are performed, the heating temperature may be set appropriately in accordance with the raw material composition and the like, and usually the heating temperature is preferably within the range of 1,350 degrees (celsius) to 1,450 degrees (celsius), and especially 1,380 degrees (celsius) to 1,430 degrees (celsius).

The base glass is pulverized into a glass powder in order to be used as a paste. The pulverizing method is not specifically limited and a known pulverizing method may be used. Examples of pulverizing methods include liquid phase pulverizing methods using a bead mill and vapor phase pulverizing methods using a jet mill The glass powder employed contains a non-phase-separable glass powder and may contain a phase-separable glass powder besides the non-phase-separable glass powder.

The paste contains a thermoplastic resin, a plasticizer, a solvent, and the like in addition to the above-described glass powder. It is desirable that the proportion of the glass powder contained in the paste be within the range of 30.0 percent by weight or more and 90.0 percent by weight or less, and preferably 35.0 percent by weight or more and 70.0 percent by weight or less.

The thermoplastic resin contained in the paste is a component that enhances the film strength after drying and imparts flexibility. As for the thermoplastic resin, polybutyl methacrylate, polyvinyl butyral, polymethyl methacrylate, polyethyl methacrylate, ethyl cellulose, and the like may be used. These thermoplastic resins may be used alone or in combination. The content of the above-described thermoplastic resin contained in the paste is preferably 0.1 percent by weight or more and 30.0 percent by weight or less. If the content is less than 0.1 percent by weight, the film strength after drying tends to become low. If the content is more than 30.0 percent by weight, unfavorably, residual components of the resin remain easily in the glass in formation of the glass layer.

Examples of plasticizers contained in the paste include butylbenzyl phthalate, dioctyl phthalate, diisooctyl phthalate, dicapryl phthalate, and dibutyl phthalate. These plasticizers may be used alone or in combination. The content of the plasticizer contained in the paste is preferably 10.0 percent by weight or less. Addition of the plasticizer may control the drying rate and impart flexibility to a dried film.

Examples of solvent contained in the paste include terpineol, diethylene glycol monobutyl ether acetate, and 2,2,4-trimethyl-1,3-pentanediol monoisobutyrate. The above-described solvents may be used alone or in combination. The content of the solvent contained in the paste is preferably 10.0 percent by weight or more and 90.0 percent by weight or less. If the content is less than 10.0 percent by weight, a uniform film is not obtained easily. If the content is more than 90.0 percent by weight, a uniform film is not obtained easily.

The paste may be produced by kneading the above-described materials at a predetermined ratio. A glass powder layer may be formed by applying the thus produced paste to the first base material layer 102 by using a screen printing method and drying and removing the solvent component of the paste.

The second base material layer 101 is formed by fusing or melting the powder of the glass powder layer. In fusion of the glass powder layer, a heat treatment can be performed at a temperature higher than or equal to the glass transition temperature of the glass powder layer. If the temperature is lower than the glass transition temperature, fusion of particles of the powder with each other does not proceed and a smooth glass layer tends not to be formed.

A step of removing the solvent component of the paste and a step of fusing or melting the glass powder layer may also serve as a step of forming a phase-separable glass layer and a phase separation treatment step performed later. In that case, the glass powder layer corresponds to the second base material layer 101.

In order to achieve a predetermined thickness, the glass paste may be repeatedly applied an appropriate number of times and be dried.

The temperature and the time of the drying and removal of the solvent may be changed appropriately in accordance with the solvent employed, although the drying can be performed at a temperature lower than the decomposition temperature of the thermoplastic resin. If the drying temperature is higher than the decomposition temperature of the thermoplastic resin, glass particles are not fixed, and when a glass powder layer is formed, occurrences of defects and unevenness tend to become considerable.

Employment of the first base material layer 102 exerts an effect of suppressing strain of a glass layer due to a heat treatment in the phase separation step and an effect of adjusting the thickness of the porous glass layer 202 easily.

The first base material layer 102 is finally converted to a part of the base member 105 and the gradient region 107. The material for the first base material layer 102 is not specifically limited insofar as silicon is contained, and the same material as that for the above-described base member 105, for example, quartz glass or quartz may be used.

The softening temperature of the base member can be higher than or equal to the heating temperature (phase separation temperature) in the phase separation step described later, and especially be higher than or equal to the temperature determined by adding 100 degrees (celsius) to the phase separation temperature. In the case where the base member is a crystal, the fusion temperature is specified to be the softening temperature. If the softening temperature is lower than the phase separation temperature, a strain of the first base material layer 102 (base member 105) may occur in the phase separation step unfavorably. The phase separation temperature refers to a maximum temperature of the heating temperatures to induce spinodal type phase separation.

The first base material layer 102 can have resistance to etching of the phase-separated glass layer.

Step of Forming Phase-Separable Glass Layer

As shown in FIG. 7B, the phase-separable glass layer 201 including a composition gradient region 104 is formed on the base member 105 by mutually diffusing a component contained in the first base material layer 102 and a component contained in the second base material layer 101. The composition gradient region 104 refers to a region in which the silicon content decreases from the base member 105 toward the surface of the phase-separable glass layer 201. In the example shown in FIG. 7B, the phase-separable glass layer 201 includes a region 103 having a constant silicon content. However, the composition gradient region 104 may be disposed throughout the phase-separable glass layer 201.

Any technique may be employed to diffuse silicon. In particular, the heat treatment can be performed at a temperature higher than or equal to the fusion temperature of the phase-separable glass layer 201. The reason for this is estimated as described below.

When the second base material layer 101 is in a fused state during diffusion of components, diffusion of silicon from the surface layer of the first base material layer 102 to the second base material layer 101 proceeds easily, the silicon content in the second base material layer 101 increases gradually, and the composition changes in such a way as to have a phase separation property.

The silicon content of the second base material layer 101 is small at the start of diffusion of components, and the viscosity of the second base material layer 101 in the fused state is low. Therefore, silicon which has diffused from the first base material layer 102 further diffuses to the surface of the second base material layer 101. As the silicon content in the second base material layer 101 increases, the viscosity of the second base material layer 101 increases. In particular, it is believed that the viscosity in the vicinity of the interface between the first base material layer 102 close to the silicon supply source and the second base material layer 101 is higher than the viscosity of the surface of the second base material layer 101. That is, it is believed that distribution is present in the viscosity. Consequently, silicon which has diffused from the first base material layer 102 does not diffuse to the surface of the second base material layer 101 easily, and the composition gradient region of the silicon content is formed in the vicinity of the interface of the second base material layer 101 to the first base material layer 102. It is believed that the distribution of the viscosity is further facilitated because of this composition gradient region, silicon comes into the state in which diffusion does not occur easily, diffusion of silicon is suppressed and, as a result, the composition gradient of silicon from the base member 105 side toward the surface side of the phase-separable glass layer 201 becomes further gentle.

Such component diffusion converts the first base material layer 102 to the composition gradient region 104 and the base member 105 having the same composition as the composition of the first base material layer 102, and converts the second base material layer 101 to the composition gradient region 104 of the phase-separable glass layer 201. The second base material layer 101 may be converted to the composition gradient region 104 of the phase-separable glass layer 201 and the region 103 having a constant silicon content.

The fusion temperature of the glass is calculated as described below. The behavior during heating of a glass subjected to the fusion temperature measurement is observed with a microscope, the heating temperature is raised, and a temperature at which fusion is observed is specified to be the fusion temperature. Specifically, a glass sample to be measured is pulverized and is placed on a quartz glass plate. Observation is performed in a field of view at a magnification of 750× by using a microscope (Imager.A1M produced by ZEISS) provided with a heating stage. The sample shape is observed with a heating microscope, and a temperature at which the glass is fused is specified to be the fusion temperature. The fusion temperature may be set appropriately in accordance with the glass composition and the like. Usually, the fusion temperature is within the range of 500 degrees (celsius) to 1,450 degrees (celsius), and preferably 500 degrees (celsius) to 1,000 degrees (celsius). If fusing is performed at a temperature higher than 1,450 degrees (celsius), the glass composition may be changed by vaporization of the glass component.

It is desirable that the resulting phase-separable glass layer 201 becomes, for example, silicon oxide based glass I (silicon oxide-boron oxide-alkali metal oxide), silicon oxide based glass II (silicon oxide-boron oxide-alkali metal oxide-(at least one type of alkaline-earth metal oxide, zinc oxide, aluminum oxide, zirconium oxide)), silicon oxide based glass III (silicon oxide-phosphate-alkali metal oxide), and titanium oxide based glass (silicon oxide-boron oxide-calcium oxide-magnesium oxide-aluminum oxide-titanium oxide). Among them, borosilicate based glass composed of silicon oxide based glass I can be employed. In particular, the borosilicate based glass having a composition in which the proportion of silicon oxide is 55.0 percent by weight or more and 95.0 percent by weight or less, and especially 60.0 percent by weight or more and 85.0 percent by weight or less can be employed. In the case where the proportion of silicon oxide is in the above-described range, phase-separated glass having high skeletal strength tends to be obtained easily and, therefore, is useful in applications where the strength is required.

Step of Forming Phase-Separated Glass Layer and Step of Forming Porous Glass Layer

As shown in FIG. 7C, the phase-separable glass layer is phase-separated, so as to form the phase-separated glass layer, and the phase-separated glass layer is etched, so as to form the porous glass layer 202 on the base member 105. As a result, in the porous glass layer 202, the gradient region 107 is formed, in which the porosity increases from the interface between the base member 105 and the porous glass layer 202 toward the surface of the porous glass layer 202. This gradient region 107 is a region derived from the composition gradient region 104.

More specifically, the phase separation step to form the phase-separated glass layer is performed by maintaining a temperature of 450 degrees (celsius) or higher and 750 degrees (celsius) or lower for 1 hour or more. The heating temperature in the phase separation step is not necessarily a constant temperature. The temperature may be changed continuously, or a plurality of steps at different temperatures may be employed.

It is also possible to perform the step of forming the phase-separable glass layer 201 and the step of forming the phase-separated glass layer at the same time by the heat treatment in the above-described step of forming the phase-separable glass layer 201. That is, the phase-separated glass layer may be formed by subjecting the second base material layer 101 to a heat treatment, so as to induce component diffusion and form the composition gradient region.

A non-silicon oxide rich phase is removed by the step of etching the phase-separated glass layer while a silicon oxide rich phase of the phase-separated glass layer remains. The remaining portion serves as a skeleton of the porous glass layer 202 and the portion from which the non-silicon oxide rich phase has been removed serves as a hole of the porous glass layer 202.

In general, the etching treatment to remove the non-silicon oxide rich phase is a treatment to elute the non-silicon oxide rich phase, which is a soluble phase, through contact with an aqueous solution. In general, the method for bringing the aqueous solution into contact with the glass is a method in which the glass is immersed in the aqueous solution, although not specifically limited insofar as the glass is brought into contact with the aqueous solution in the method. For example, the glass may be coated with the aqueous solution. As for the aqueous solution required for the etching treatment, known solutions, e.g., water, acid solutions, and alkaline solutions, capable of dissolving the non-silicon oxide rich phase may be used. A plurality of types of step to bring the glass into contact with these aqueous solutions may be selected in accordance with uses.

In the etching treatment of common phase-separated glass, an acid treatment is used favorably from the viewpoints of a small load on an insoluble phase (silicon oxide rich phase) and the degree of selective etching. The non-silicon oxide rich phase, which is an acid-soluble component, is removed through elution because of contact with an acid solution, while corrosion of the silicon oxide rich phase is relatively small, so that high selective etchability is ensured.

Examples of acid solutions can include inorganic acids, e.g., hydrochloric acid and nitric acid. As for the acid solution, usually, an aqueous solution by using water as a solvent can be employed. Usually, the concentration of the acid solution may be specified to be within the range of 0.1 to 2.0 mol/L appropriately. In the acid treatment step, the temperature of the acid solution may be specified to be within the range of room temperature to 100 degrees (celsius) and the treatment time may be specified to be about 1 to 500 hours.

Several ten nanometers of silicon oxide layer, which hinders etching, may be generated on the glass surface after the phase separation heat treatment depending on the glass composition and the production condition. This surface silicon oxide layer may be removed by polishing, an alkali treatment, or the like. Part of the soluble layer may deposit as gel silicon oxide on the skeleton depending on the etching condition. If the gel silicon oxide is present, the stability of the environment and the like of the optical member tends to be degraded.

If necessary, a multistage etching method using acid etching solutions having different acidities or water may be employed. Etching may be performed at etching temperatures of room temperature (20 degrees (celsius)) to 100 degrees (celsius). Ultrasonic waves may be applied during the etching treatment, if necessary.

In general, a water treatment (Etching step 2) can be performed after a treatment with an acid solution, an alkaline solution, or the like (Etching step 1) is performed. In the case where the water treatment is performed, adhesion of residual components to a porous glass skeleton is suppressed and a porous glass having a higher porosity tends to be obtained.

In general, the temperature in the water treatment step is preferably within the range of room temperature (20 degrees (celsius)) to 100 degrees (celsius). The duration of the water treatment step is specified appropriately in accordance with the composition, the size, and the like of the glass concerned and may be usually about 1 hour to 50 hours.

### EXAMPLES

The present invention will be described below with reference to the examples. However, the present invention is not limited to the examples.

### Base Member 1

A quartz base member (produced by IIYAMA PRECISION GLASS CO., LTD., softening point 1,700 degrees (celsius), Young's modulus 72 GPa) was used as a base member 1. The base member 1 having a thickness of 0.5 mm was used after being cut into the size of 50 mm×50 mm and being subjected to mirror finishing.

### Production Example of Glass Powder 1

A mixed powder of a quartz powder, boron oxide, sodium oxide, and alumina was fused in a platinum crucible at 1,500 degrees (celsius) for 24 hours, where the charge composition was specified to be 80 percent by weight of B₂O_{3 and} 20 percent by weight of Na₂O. The fused raw material was poured into a graphite mold after the temperature was lowered to 1,300 degrees (celsius). Standing to cool was performed in air for about 20 minutes, keeping was performed in a slow cooling furnace at 500 degrees (celsius) for 5 hours, and finally, cooling was performed for 24 hours, so as to obtain alkali borate glass. When this alkali borate glass was heat-treated under the temperature condition of production of an optical member described later, phase separation phenomenon was not observed.

The resulting block of the alkali borate glass was pulverized until the average particle diameter became 2.0 micrometers, so as to obtain the glass powder 1. The abundance ratio of Si in the resulting glass powder 1 was 0 atomic percent and the fusion temperature was 600 degrees (celsius).

### Production Example of Glass Powder 2

A mixed powder of a quartz powder, boron oxide, sodium oxide, and alumina was fused in a platinum crucible at 1,500 degrees (celsius) for 24 hours, where the charge composition was specified to be 64 percent by weight of SiO₂, 27 percent by weight of B₂O₃, 6 percent by weight of Na₂O, and 3 percent by weight of Al₂O₃. The fused raw material was poured into a graphite mold after the temperature was lowered to 1,300 degrees (celsius). Standing to cool was performed in air for about 20 minutes, keeping was performed in a slow cooling furnace at 500 degrees (celsius) for 5 hours, and finally, cooling was performed for 24 hours, so as to obtain borosilicate glass. When the borosilicate glass was heat-treated under the temperature condition of production of an optical member described later, phase separation phenomenon was not observed.

The resulting block of the borosilicate glass was pulverized until the average particle diameter became 4.5 micrometers, so as to obtain the glass powder 2. The abundance ratio of Si in the resulting glass powder 2 was 51 atomic percent and the fusion temperature was 850 degrees (celsius).

### Production Example of Glass Paste 1

Glass powder 1: 60.0 parts by mass

Terpineol: 44.0 parts by mass

Ethyl cellulose (registered trademark ETHOCEL Std 200 (produced by Dow Chemical Company)): 2.0 parts by mass

The above-described raw materials were agitated and mixed, so as to obtain a glass paste 1. The viscosity of the glass paste 1 was 21,500 mPas.

### Production Example of Glass Paste 2

A glass paste 2 was obtained in the same manner as the glass paste 1 except that the glass powder 2 was used in place of the glass powder 1. The viscosity of the glass paste 2 was 31,300 mPas.

### Production Example of Optical Member 1

The glass paste 1 was applied to the base member 1 through screen printing. A printing machine employed was MT-320TV produced by Micro-tec Co., Ltd. A plate 30 mm x 30 mm of #500 was used. The solvent was dried by standing in a drying furnace at 100 degrees (celsius) for 10 minutes, so as to form a glass powder film. The thickness of the resulting glass powder film was 4.2 micrometers on the basis of SEM measurement.

In a heat treatment step 1, the temperature of this film was raised to 860 degrees (celsius) at a temperature raising rate of 10 degrees (celsius)/min, a heat treatment was performed for 3 hours, and the temperature was lowered to room temperature. The composition of the glass layer was measured by XPS. As a result, it was ascertained that the Si content had a gradient toward the base member 1 in a region of about 500 nm.

In a heat treatment step 2, the temperature was lowered to 550 degrees (celsius) at a temperature lowering rate of 20 degrees (celsius)/min, a heat treatment was performed at a temperature of 550 degrees (celsius) for 25 hours, and the outermost surface of the film was polished, so as to obtain a phase-separated glass.

The phase-separated glass layer was immersed in a 1.0 mol/L nitric acid aqueous solution heated to 80 degrees (celsius) and was stood for 24 hours while being kept at 80 degrees (celsius). Then the phase-separated glass structure was immersed in distilled water heated to 80 degrees (celsius) and was stood for 24 hours. The phase-separated glass structure was taken out of the solution and was dried at room temperature for 12 hours, so as to obtain Optical member 1. The thickness of the porous glass layer 202 of Optical member 1 measured 8.5 micrometers.

FIG. 2 shows an electron microscope observation diagram (SEM image) of a crosssection of the base member 105 and the porous glass layer 202 of the optical member 203. According to observation of the optical member surface with SEM, a spinodal type porous structure due to phase separation was observed and it was supported that a surface glass layer was converted to the phase-separated glass layer. In addition, the manner of a reduction in porous skeleton of the base member 105 was observed from FIG. 2 and a region (gradient region 107) in which the porosity had a gradient in a wide range was observed. The inclination of the gradient region 107 was linear on the basis of FIG. 3.

The production condition of Optical member 1 is shown in Table 1 and the configuration is shown in Table 2.

### Production Example of Optical Member 2

In the present example, Optical member 2 was produced in the same manner as Optical member 1 except that keeping was performed at 860 degrees (celsius) for 1 hour in the heat treatment step 1. The production condition of Optical member 2 is shown in Table 1.

The thickness of the porous glass layer measured 8.0 micrometers. The manner of a reduction in porous skeleton of the base member portion was observed from the electron microscopy image and the manner of gradient of the porous structure in a wide range was observed. The inclination of the gradient region was linear.

The configuration of Optical member 2 obtained as described above is shown in Table 2.

### Production Example of Optical Member 3

In the present example, Optical member 3 was produced in the same manner as Optical member 1 except that keeping was performed at 800 degrees (celsius) for 1 hour in the heat treatment step 1, and keeping was performed at 550 degrees (celsius) for 50 hours in the heat treatment step 2. The production condition of Optical member 3 is shown in Table 1.

The thickness of the porous glass layer measured 3.8 micrometers. The manner of a reduction in porous skeleton of the base member portion was observed from the electron microscopy image and the manner of gradient of the porous structure in a wide range was observed.

The configuration of Optical member 3 obtained as described above is shown in Table 2.

### Production Example of Optical Member 4

In the present example, Optical member 4 was produced in the same manner as Optical member 1 except that the glass paste employed was changed from the glass paste 1 to the glass paste 2, keeping was performed at 700 degrees (celsius) for 1 hour in the heat treatment step 1, and keeping was performed at 600 degrees (celsius) for 50 hours in the heat treatment step 2. The production condition of Optical member 4 is shown in Table 1.

FIG. 8 shows an electron microscope observation diagram (SEM image) of a cross-section of the base member 105 and a porous glass layer 210 of Optical member 4. According to observation of the surface of Optical member 4 with an electron microscope (SEM), a spinodal type porous structure having a thickness of 7.0 micrometers due to phase separation was observed. However, a region in which the porosity had a gradient was not observed between the base member 105 and the porous structure.

The configuration of Optical member 4 obtained as described above is shown in Table 2. In Table 2, for the sake of convenience, the thickness of the gradient region was estimated as described above.

TABLE 1

| | | | Optical | Optical | Optical | Optical |
|---|---|---|---|---|---|---|
| | | | member | member | member | member |
| | | | 1 | 2 | 3 | 4 |
| Base member | | Type | Base | Base | Base | Base |
| | | | member | member | member | member |
| | | | 1 | 1 | 1 | 1 |
| | | Si abundance | 100 | 100 | 100 | 100 |
| | | ratio | | | | |
| | | (atomic %) | | | | |
| Glass | | Type | Glass 1 | Glass 1 | Glass 1 | Glass 2 |
| | | Phase | non- | non- | non- | phase- |
| | | separation | phase- | phase- | phase- | sepa- |
| | | | sepa- | sepa- | sepa- | rable |
| | | | rable | rable | rable | |
| | | Si abundance | 0 | 0 | 0 | 51 |
| | | ratio | | | | |
| | | (atomic %) | | | | |
| | | Fusion | 600 | 600 | 600 | 850 |
| | | temperature | | | | |
| | | (° C.) | | | | |
| Heat | Heat | Temperature | 860 | 860 | 800 | 700 |
| treat- | treatment | (° C.) | | | | |
| ment | step 1 | Time (hr) | 3 | 1 | 1 | 1 |
| con- | Heat | Temperature | 550 | 550 | 550 | 600 |
| dition | treatment | (° C.) | | | | |
| | step2 | Time (hr) | 25 | 25 | 50 | 50 |

TABLE 2

| | | Optical | Optical | Optical | Optical |
|---|---|---|---|---|---|
| | | member | member | member | member |
| | | 1 | 2 | 3 | 4 |
| Porous | Porosity [%] | 22 | 38 | 48 | 52 |
| glass | Hole diameter | 10 | 16 | 41 | 45 |
| layer | [nm] | | | | |
| | Skeleton diameter | 25 | 28 | 29 | 30 |
| | [nm] | | | | |
| | Thickness [μm] | 8.5 | 8.0 | 3.8 | 7.0 |
| Gradient | P/T | 0.03 | 0.11 | 0.48 | 1.30 |
| structure | Thickness [nm] | 881 | 370 | 100 | 40 |
| region | | | | | |

### Evaluation of Surface Reflectance

The surface reflectance of each of structures was measured on the basis of 1 nm in the wavelength region of 450 to 650 nm by using a lens reflectance measuring apparatus (USPM-RU, produced by Olympus Corporation).

The results of the surface reflectance are shown in FIG. 9. The reflectance of the quartz glass used as the base member was about 4.3% throughout the wavelength region of 450 nm to 650 nm. Therefore, it is clear that all Optical members 1 to 4 had a low reflectance.

Optical members 1 to 3 had reflection characteristics in which a ripple was reduced, had high transmittance of more than 93% in the wavelength region of 450 nm to 650 nm, exhibited excellent in terms of optical performance and, therefore, are utilized as optical members having a low reflectance. As for Optical member 4, a ripple was considerable and the transmittance was 80%. Therefore, utilization as an optical member is difficult to a small extent.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-253070, filed Nov. 18, 2011, and Japanese Patent Application No. 2012-222900, filed Oct. 5, 2012, which are hereby incorporated by reference herein in their entirety.

### REFERENCE SIGNS LIST 101 First base material layer

102 Second base material layer

104 Composition gradient region

105 Base member

107 Gradient region

201 Phase-separated glass layer

202 Porous glass layer

203 Optical member

1. An optical member comprising:
a base member; and
a porous glass layer disposed on the base member and having a thickness of 400 nm or more,
wherein the porous glass layer includes at least a gradient region having a porosity increasing from the interface between the base member and the porous glass layer toward the surface of the porous glass layer,
the porosity is continuous in the thickness direction from the base member to the surface of the porous glass layer, and
the porosity difference P (%) between two ends of the gradient region and the thickness T (nm) of the gradient region satisfy the relationship represented by P/T less than or equal to 0.60.

2. The optical member according to claim 1, wherein the porosity difference P (%) and the thickness T (nm) satisfy the relationship represented by P/T less than or equal to 0.30.

3. The optical member according to claim 1, wherein the porosity difference P (%) and the thickness T (nm) satisfy the relationship represented by
P/T less than or equal to 0.10.

4. The optical member according to claim 1, wherein the porosity of the gradient region increases monotonously toward the surface of the porous glass layer.

5. The optical member according to claim 1, wherein the thickness T of the gradient region is 100 nm or more.

6. The optical member according to claim 1, wherein the thickness T of the gradient region is 200 nm or more.

7. The optical member according to claim 1, wherein the thickness T of the gradient region is 400 nm or more.

8. The optical member according claim 1, wherein the porous glass layer includes a region having a constant porosity.

9. An image pickup apparatus comprising:
the optical member according to claim 1; and
an image pickup element.

10. A method for manufacturing an optical member provided with a porous glass layer disposed on a base member, comprising the steps of:
forming a non-phase-separable second base material layer on a non-phase-separable first base material layer containing silicon;
forming a phase-separable glass layer including a composition gradient region by mutually diffusing silicon contained in the first base material layer and a component contained in the second base material layer;
forming a phase-separated glass layer by phase-separating the phase-separable glass layer; and
forming a porous glass layer on the base member by etching the phase-separated glass layer.

11. The method for manufacturing an optical member, according to claim 10, wherein the forming of the phase-separable glass layer includes a heat treatment at a temperature higher than or equal to the fusion temperature of the second base material layer.

12. The method for manufacturing an optical member, according to claim 10, wherein the forming of the phase-separable glass layer and the forming of the phase-separated glass layer are performed at the same time.
